(19) United States
(12) Patent Application Publication
(10) Pub. No.: US 2013/0090958 A1
(43) Pub. Date: Apr. 11, 2013

(54) MOBILE ELECTRONIC DEVICE INTERACTIVE APPLICATION METHOD AND MOBILE ELECTRONIC DEVICE INTERACTIVE APPLICATION SYSTEM

(71) Applicant: ITOUCH MEDIA INC., Taipei City (TW)

(72) Inventors: Chi-Yuan Chin, Taipei City (TW); Hsin-Chih Fu, Taoyuan County (TW)

(73) Assignee: ITOUCH MEDIA INC., Taipei City (TW)

(21) Appl. No.: 13/645,395

(22) Filed: Oct. 4, 2012

(30) Foreign Application Priority Data
Oct. 7, 2011 (TW) 100136578

(51) Int. Cl. H04W 4/00; G06Q 30/02; H04W 4/14; G06Q 10/02

(52) U.S. Cl. 705/5; 455/414.1; 705/14.12

(57) ABSTRACT

The present invention provides a mobile electronic device interactive application method and a mobile electronic device interactive application system. The mobile electronic device interactive application method comprises: broadcasting at least an information on a display device; utilizing a mobile electronic device to generate at least a signal according to the at least an information, wherein the mobile electronic device at least has a telecommunication function or a wireless network function; and utilizing an interactive device to receive the at least a signal and to perform an interactive operation according to the at least a signal via a network. The mobile electronic device interactive application system comprises: a display device, a mobile electronic device, and an interactive device, wherein the interactive device comprises: a broadcasting module and an interactive module.

### BACKGROUND OF THE INVENTION

1. Field of the Invention

The present invention relates to a mobile electronic device interactive application method and a mobile electronic device interactive application system, and more particularly, to a mobile electronic device interactive application method and a mobile electronic device interactive application system which can let media owners increase the competitive strength of their media, and fascinate consumers to watch and use the media, and precisely quantify the dissemination effects of the media by enriching interactive programs, wherein the mobile electronic device at least has a telecommunication function or a wireless network function.

2. Description of the Prior Art

In general, a conventional outdoor large electronic commercial billboard only broadcast a media content (such as a commercial advertisement), and a consumer does not has a selecting right for the media content broadcasted by the conventional outdoor large electronic commercial billboard, but only receives the media content passively. Please refer to FIG. 1. FIG. 1 shows a simplified block diagram of a conventional electronic commercial billboard broadcasting system 100 in accordance with a prior art. As shown in FIG. 2, the conventional electronic commercial billboard broadcasting system 100 comprises: an electronic commercial billboard 102, a broadcasting system 104, a broadcasting software 106, and a commercial advertisement 108. It is the most important to set the conventional electronic commercial billboard broadcasting system 100 in a location with more people and vehicles passing through to make the conventional electronic commercial billboard broadcasting system 100 have a higher watching rating. However, there are very limited locations with more people and vehicles passing through in a region, and thus the there is a very limited number of the conventional electronic commercial billboard broadcasting system 100 for setting.

Another disadvantage of the conventional electronic commercial billboard broadcasting system 100 is that it is very difficult to quantify the dissemination effects of the conventional electronic commercial billboard broadcasting system 100. For example, the conventional electronic commercial billboard broadcasting system 100 is not capable of knowing how many consumers watch the commercial advertisement on the electronic commercial billboard 102, and thus the watching rating can not be calculated precisely. In addition, the content broadcasted by the conventional electronic commercial billboard broadcasting system 100 is mainly the commercial advertisement, and most consumers do not care about the content broadcasted by the conventional electronic commercial billboard broadcasting system 100, and thus, if the commercial advertisement broadcasted by the conventional electronic commercial billboard broadcasting system 100 is not novel or interesting enough, most consumers will not halt to watch the commercial advertisement. Or, even there are consumers watching the commercial advertisement, their watching time is very short. In other words, it is very hard for the conventional electronic commercial billboard broadcasting system 100 to attract attention of most consumers.

### SUMMARY OF THE INVENTION

It is therefore one of the objectives of the present invention to provide a mobile electronic device interactive application method and a mobile electronic device interactive application system, which can let media owners increase the competitive strength of their media, and fascinate consumers to watch and use the media, and precisely quantify the dissemination effects of the media by enriching interactive programs, so as to solve the above problem.

In accordance with an embodiment of the present invention, a mobile electronic device interactive application method is disclosed. The mobile electronic device interactive application method comprises: broadcasting at least an information on a display device; utilizing a mobile electronic device to generate at least a signal according to the at least an information, wherein the mobile electronic device at least has a telecommunication function or a wireless network function; and utilizing an interactive device to receive the at least a signal via a network and to perform an interactive operation according to the at least a signal.

In accordance with an embodiment of the present invention, a mobile electronic device interactive application system is disclosed. The mobile electronic device interactive application system comprises: a display device, a mobile electronic device, and an interactive device. The display device is utilized for broadcasting at least an information. The mobile electronic device is utilized for generating at least a signal according to the at least an information, wherein the mobile electronic device at least has a telecommunication function or a wireless network function. The interactive device is coupled to the display device, and utilized for receiving the at least a signal via a network and performing an interactive operation with the mobile electronic device according to the at least a signal, wherein the interactive device comprises: a broadcasting module and an interactive module. The broadcasting module is coupled to the display device, and utilized for controlling the display device, and the interactive module is coupled to the broadcasting module, and utilized for receiving the at least a signal via the network and performing the interactive operation with the mobile electronic device according to the at least a signal, and controlling the broadcasting module.

Briefly summarized, the mobile electronic device interactive application method and the mobile electronic device interactive application system disclosed by the present invention can let media owners increase the competitive strength of their media, and fascinate consumers to watch and use the media, and precisely quantify the dissemination effects of the media by enriching interactive programs, so as to solve the problems of conventional display device broadcasting system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional electronic commercial billboard broadcasting system in accordance with a prior art.

FIG. 2 shows a simplified block diagram of a mobile electronic device interactive application system in accordance with an embodiment of the present invention.

FIG. 3 is a flowchart showing a mobile electronic device interactive application method of a first embodiment in accordance with the above operation schemes of the mobile electronic device interactive application system in FIG. 2 of the present invention.

FIG. 4A and FIG. 4B show a flowchart of a mobile electronic device interactive application method in accordance with a second embodiment of the present invention when the interactive operation in FIG. 3 is a ticket booking operation.

FIG. 5A and FIG. 5B show a flowchart of a mobile electronic device interactive application method in accordance with a third embodiment of the present invention when the interactive operation in FIG. 3 is an interactive prize presenting operation.

FIG. 6 shows a flowchart of a mobile electronic device interactive application method in accordance with a fourth embodiment of the present invention when the interactive operation in FIG. 3 is a personal message operation.

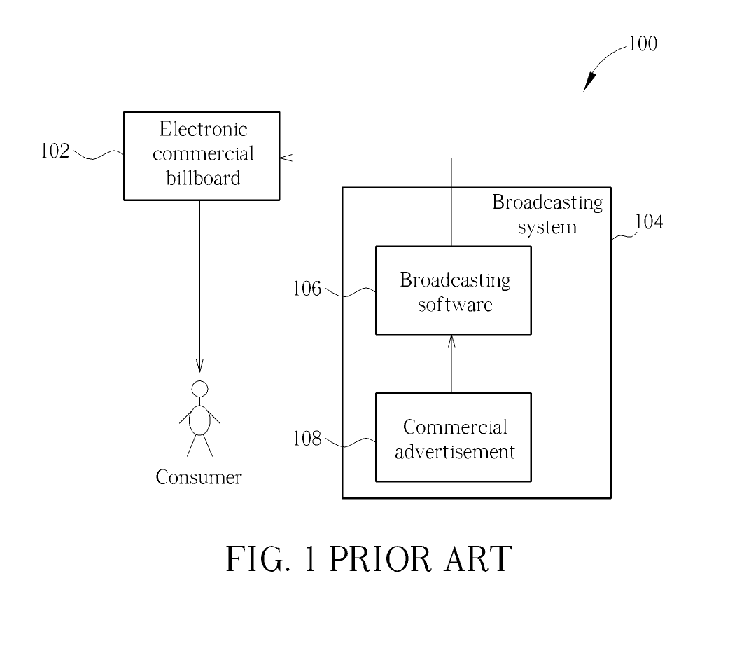

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . .” The terms “couple” and “coupled” are intended to mean either an indirect or a direct electrical connection. Thus, if a first device couples to a second device, that connection may be through a direct electrical connection, or through an indirect electrical connection via other devices and connections.

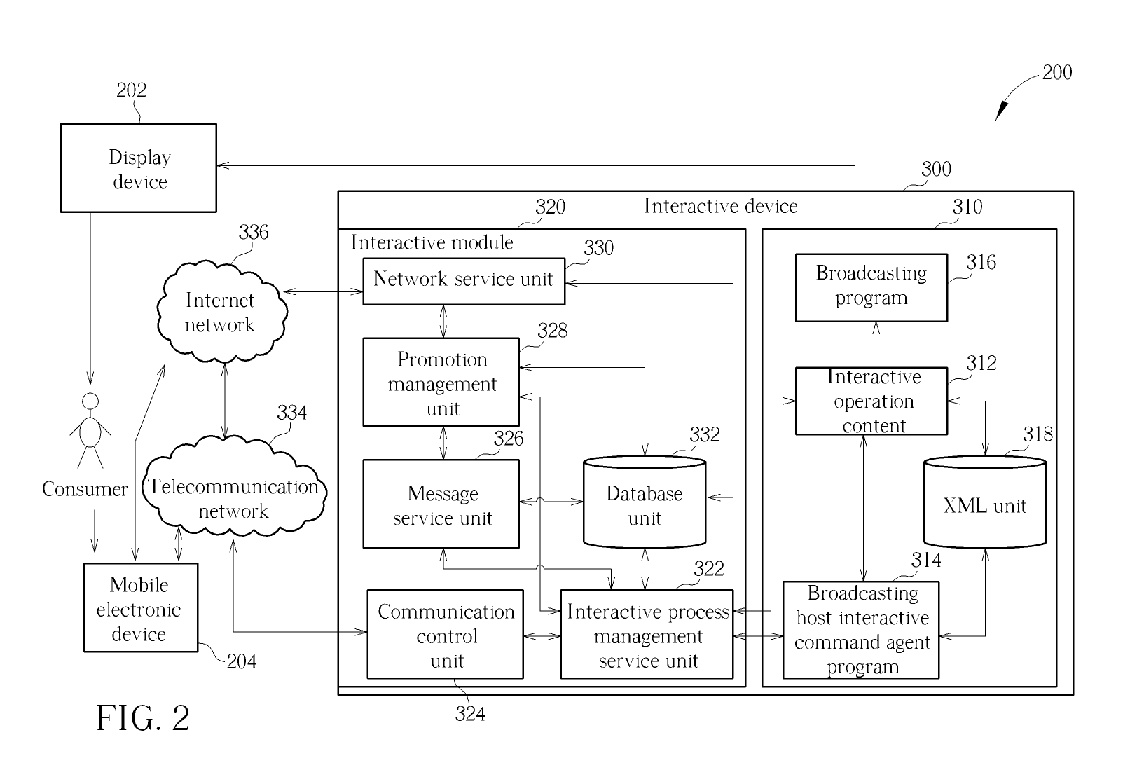

Please refer to FIG. 2. FIG. 2 shows a simplified block diagram of a mobile electronic device interactive application system 200 in accordance with an embodiment of the present invention. As shown in FIG. 2, the mobile electronic device interactive application system 200 comprises: a display device 202, a mobile electronic device 204, and an interactive device 300. The display device 202 is utilized for broadcasting at least an information, and the mobile electronic device 204 is utilized for generating at least a signal according to the at least an information, wherein the mobile electronic device 204 at least has a telecommunication function or a wireless network function. For example, the mobile electronic device 204 can be a cellphone. The interactive device 300 is coupled to the display device 202, and utilized for receiving the at least a signal via a network (such as a telecommunication network 334 or an internet network 336) and performing an interactive operation with the mobile electronic device 204 according to the at least a signal, wherein the interactive device 300 comprises: a broadcasting module 310 and an interactive module 320. The broadcasting module 310 is coupled to the display device 202, and utilized for controlling the display device 202, and the interactive module 320 is coupled to the broadcasting module 310, and utilized for receiving the at least a signal via the network (i.e. the telecommunication network 334 (such as a cell phone network) or the internet network 336) and performing the interactive operation with the mobile electronic device 204 according to the at least a signal, and controlling the broadcasting module 310. In addition, the broadcasting module 310 can comprise: an interactive operation content 312, a broadcasting host interactive command agent program 314, a broadcasting program 316, and an eXtensible Markup Language (XML) unit 318, and the interactive module 320 can comprise: an interactive process management service unit 322, a communication control unit 324, a message service unit 326, a promotion management unit 328, a network service unit 330, and a database unit 332. The interactive process management service unit 322 is utilized for processing the at least a signal generated by the mobile electronic device 204. The communication control unit 324 is coupled to the interactive process management service unit 322, and utilized for receiving the at least a signal, wherein the communication control unit 324 comprises a GSM signal control function and a general audio signal control function. The message service unit 326 is coupled to the interactive process management service unit 322, and utilized for processing at least a message or at least a short message. The promotion management unit 328 is coupled to the message service unit 326 and the interactive process management service unit 322, and utilized for managing at least a content information which is going to be promoted by at least a content vendor. The network service unit 330 is coupled to the promotion management unit 328, and utilized for providing at least an internet version operational interface which is proper for the mobile electronic device 204 to browse. The database unit 332 is coupled to the interactive process management service unit 322, the message service unit 326, the promotion management unit 328, and the network service unit 330, and utilized for storing data generated by the interactive process management service unit 322, the message service unit 326, the promotion management unit 328, and the network service unit 330.

The objective of the mobile electronic device interactive application system 200 in the present invention is to provide a real-time interactive platform for the media content vendors and the consumers. For example, when a consumer watches an advertisement on an outdoor large electronic commercial billboard or an outdoor large display device, and is interested in the content of the advertisement and has desires of consumption, the consumer can use a cell phone to dial a phone number provided by the advertisement, or use the cell phone to use mobile internet to login a website provided by the advertisement, so as to get the service content required by the consumer. In addition, please note that the above embodiment is only for an illustrative purpose and is not meant to be a limitation of the present invention. For example, the outdoor large electronic commercial billboard or the outdoor large display device mentioned above can be replaced by an indoor electronic commercial billboard or an indoor display device (for example, the electronic commercial billboard or the display device in a public area such as an elevator and traffic station), or a plasma display device, an LCD display device or various electronic display devices in an ordinary family, a meeting room of a company, and a wedding place. Besides, the consumer also can use other kinds of mobile electronic devices (such as a notebook computer, a tablet computer, and a smart phone) to perform the interactive operation with the mobile electronic device interactive application system 200 in the present invention.

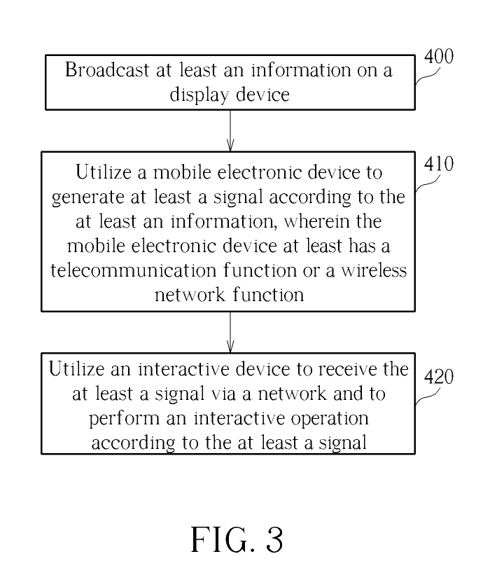

Please refer to FIG. 3. FIG. 3 is a flowchart showing a mobile electronic device interactive application method of a first embodiment in accordance with the above operation schemes of the mobile electronic device interactive application system 200 of the present invention. Provided that substantially the same result is achieved, the steps of the process flowchart need not be in the exact order shown in FIG. 3 and need not be contiguous, that is, other steps can be intermediate. The mobile electronic device interactive application method in the first embodiment of the present invention comprises the following steps:

Step 400: Broadcast at least an information on a display device.

Step 410: Utilize a mobile electronic device to generate at least a signal according to the at least an information, wherein the mobile electronic device at least has a telecommunication function or a wireless network function.

Step 420: Utilize an interactive device to receive the at least a signal via a network and to perform an interactive operation according to the at least a signal.

In addition, please note that the above embodiment is only for an illustrative purpose and is not meant to be a limitation of the present invention. For example, after the Step 420, the mobile electronic device interactive application system 200 and the mobile electronic device interactive application method in the first embodiment of the present invention can be further combined with various cash flow mechanisms (such as a credit card payment mechanism and a bank transfer payment mechanism, etc.), so that the ordinary consumers can pay money to obtain corresponding service contents via the platform provided by the present invention. Since the various cash flow mechanisms are all well known to those of average skill in this art, and thus further explanation of the details and operations are omitted herein for the sake of brevity. Next, various different interactive operations will be illustrated in the following paragraphs of this document.

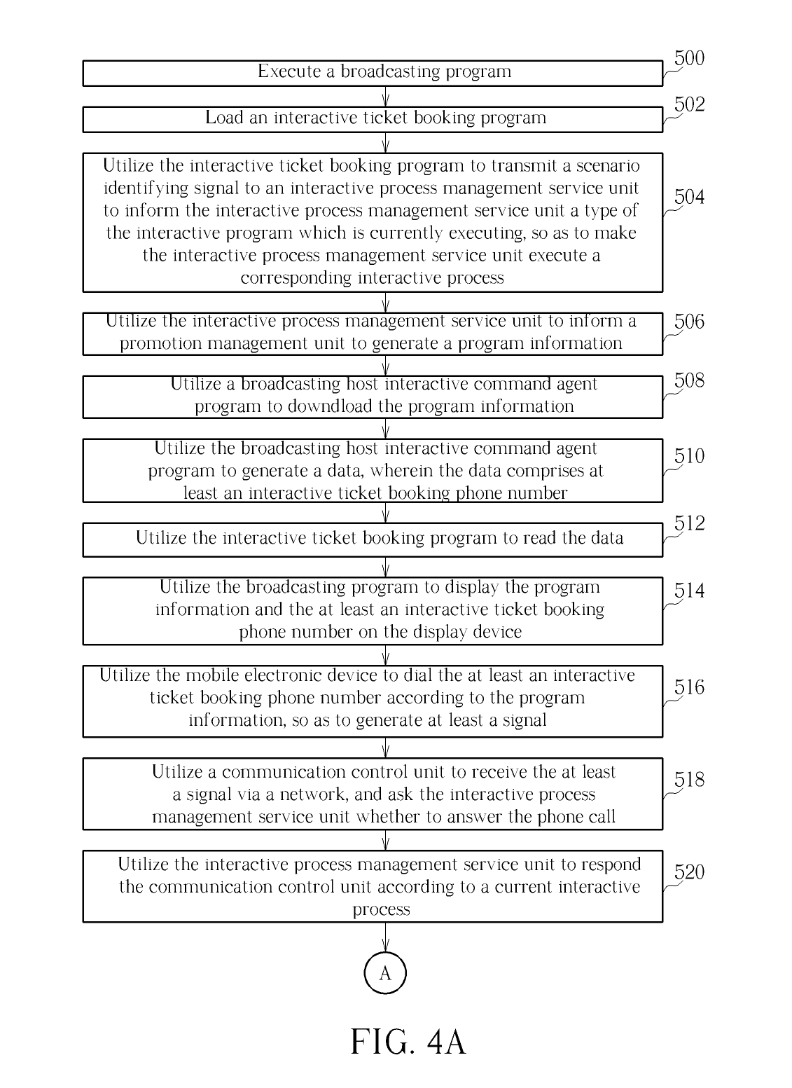

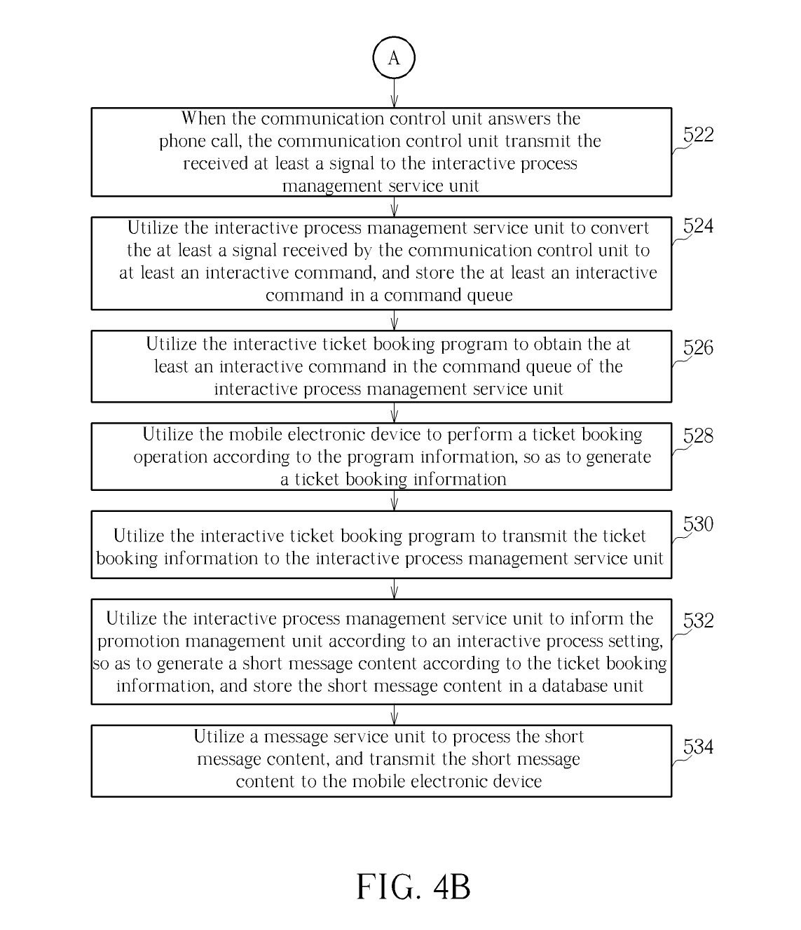

Please refer to FIG. 4A and FIG. 4B. FIG. 4A and FIG. 4B show a flowchart of a mobile electronic device interactive application method in accordance with a second embodiment of the present invention when the interactive operation in FIG. 3 is a ticket booking operation. Provided that substantially the same result is achieved, the steps of the process flowchart need not be in the exact order shown in FIG. 4A and FIG. 4B and need not be contiguous, that is, other steps can be intermediate. The mobile electronic device interactive application method in the second embodiment of the present invention comprises the following steps:

Step 500: Execute a broadcasting program.

Step 502: Load an interactive ticket booking program.

Step 504: Utilize the interactive ticket booking program to transmit a scenario identifying signal to an interactive process management service unit to inform the interactive process management service unit a type of the interactive program which is currently executing, so as to make the interactive process management service unit execute a corresponding interactive process.

Step 506: Utilize the interactive process management service unit to inform a promotion management unit to generate a program information.

Step 508: Utilize a broadcasting host interactive command agent program to download the program information.

Step 510: Utilize the broadcasting host interactive command agent program to generate a data, wherein the data comprises at least an interactive ticket booking phone number.

Step 512: Utilize the interactive ticket booking program to read the data.

Step 514: Utilize the broadcasting program to display the program information and the at least an interactive ticket booking phone number on the display device.

Step 516: Utilize the mobile electronic device to dial the at least an interactive ticket booking phone number according to the program information, so as to generate at least a signal.

Step 518: Utilize a communication control unit to receive the at least a signal via a network, and ask the interactive process management service unit whether to answer the phone call.

Step 520: Utilize the interactive process management service unit to respond the communication control unit according to a current interactive process.

Step 522: When the communication control unit answers the phone call, the communication control unit transmit the received at least a signal to the interactive process management service unit.

Step 524: Utilize the interactive process management service unit to convert the at least a signal received by the communication control unit to at least an interactive command, and store the at least an interactive command in a command queue.

Step 526: Utilize the interactive ticket booking program to obtain the at least an interactive command in the command queue of the interactive process management service unit.

Step 528: Utilize the mobile electronic device to perform a ticket booking operation according to the program information, so as to generate a ticket booking information.

Step 530: Utilize the interactive ticket booking program to transmit the ticket booking information to the interactive process management service unit.

Step 532: Utilize the interactive process management service unit to inform the promotion management unit according to an interactive process setting, so as to generate a short message content according to the ticket booking information, and store the short message content in a database unit.

Step 534: Utilize a message service unit to process the short message content, and transmit the short message content to the mobile electronic device.

In addition, the step of utilizing the message service unit to process the short message content can further comprise: checking whether there is any short message content which is not processed in the database unit; and when the message service unit determines there is a short message content which is not processed in the database unit, utilizing the message service unit to process the short message content which is not processed.

In brief, the mobile electronic device interactive application system 200 and the mobile electronic device interactive application method in the second embodiment of the present invention can be utilized in booking and buying various tickets (such as a movie ticket, a concert ticket, and a sport game ticket, etc.). For example, when a consumer watches an advertisement film of a concert displaying on an outdoor large electronic commercial billboard or an outdoor large display device, the consumer can use a cell phone to dial a phone number provided by the advertisement film, so as to enter the mobile electronic device interactive application system 200 of the present invention to perform a ticket booking operation. During the ticket booking operation, the consumer can input information comprising a participating date, a participating time, and a seat number. Next, after the consumer successfully complete the ticket booking operation, the mobile electronic device interactive application system 200 of the present invention will send a message comprising the ticket information (such as a date, a time, a seat number, a price, and a ticket booking code, etc.) to the consumer, and the consumer can use a following cash flow mechanism via the mobile electronic device interactive application system 200 of the present invention according to the message, so as to buy the ticket. In addition, please note that the above embodiment is only for an illustrative purpose and is not meant to be a limitation of the present invention. For example, the outdoor large electronic commercial billboard or the outdoor large display device mentioned above can be replaced by an indoor electronic commercial billboard or an indoor display device (for example, the electronic commercial billboard or the display device in a public area such as an elevator and traffic station), or a plasma display device, an LCD display device or various electronic display devices in an ordinary family, a meeting room of a company, and a wedding place. Besides, the consumer also can use other kinds of mobile electronic devices (such as a notebook computer, a tablet computer, and a smart phone) to perform the ticket booking operation with the mobile electronic device interactive application system 200 in the present invention.

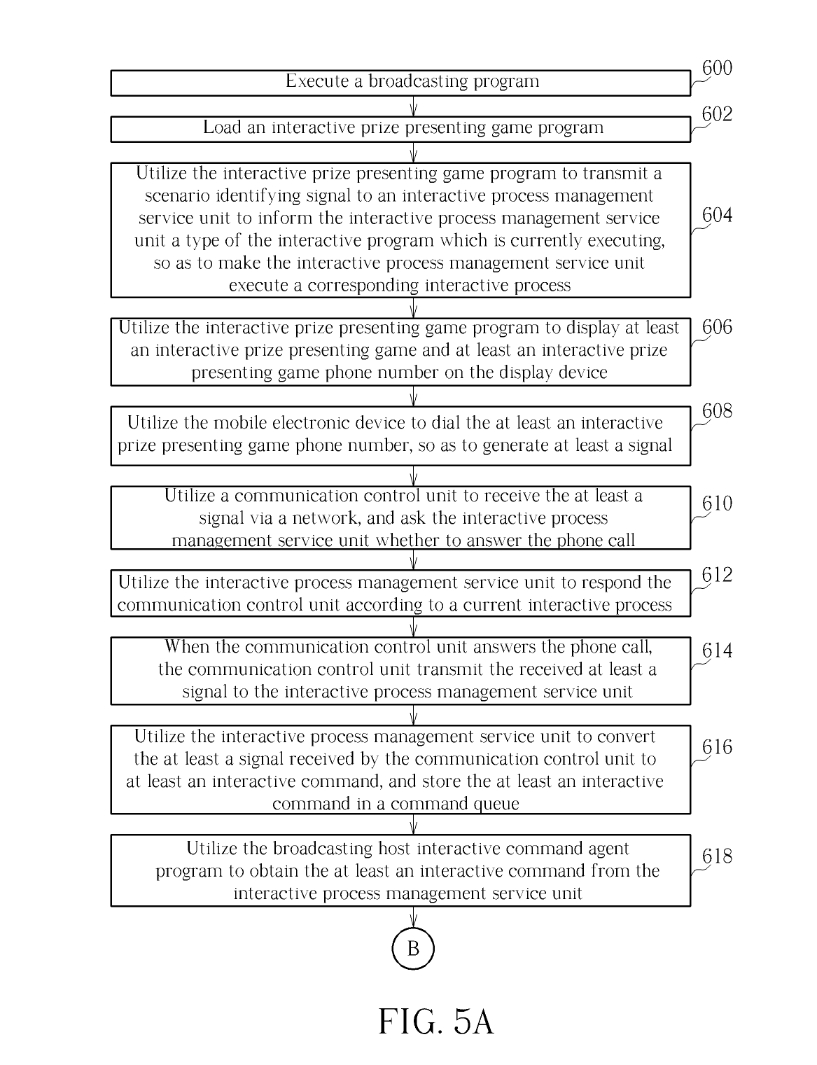

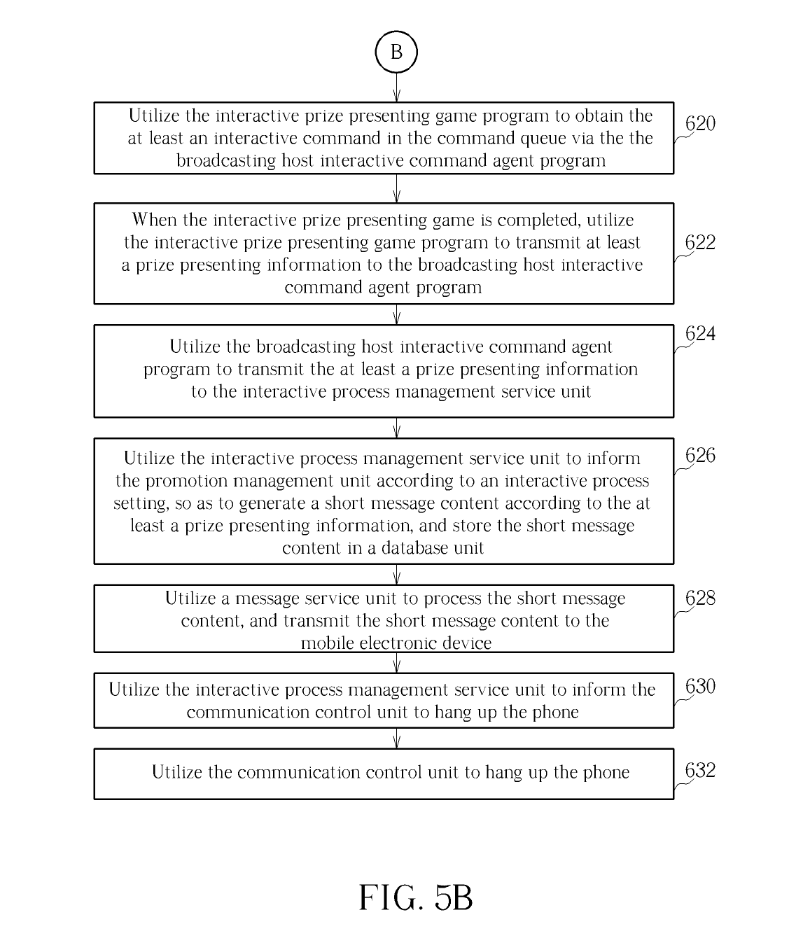

Please refer to FIG. 5A and FIG. 5B. FIG. 5A and FIG. 5B show a flowchart of a mobile electronic device interactive application method in accordance with a third embodiment of the present invention when the interactive operation in FIG. 3 is an interactive prize presenting operation. Provided that substantially the same result is achieved, the steps of the process flowchart need not be in the exact order shown in FIG. 5A and FIG. 5B and need not be contiguous, that is, other steps can be intermediate. The mobile electronic device interactive application method in the third embodiment of the present invention comprises the following steps:

Step 600: Execute a broadcasting program.

Step 602: Load an interactive prize presenting game program.

Step 604: Utilize the interactive prize presenting game program to transmit a scenario identifying signal to an interactive process management service unit to inform the interactive process management service unit a type of the interactive program which is currently executing, so as to make the interactive process management service unit execute a corresponding interactive process.

Step 606: Utilize the interactive prize presenting game program to display at least an interactive prize presenting game and at least an interactive prize presenting game phone number on the display device.

Step 608: Utilize the mobile electronic device to dial the at least an interactive prize presenting game phone number, so as to generate at least a signal.

Step 610: Utilize a communication control unit to receive the at least a signal via a network, and ask the interactive process management service unit whether to answer the phone call.

Step 612: Utilize the interactive process management service unit to respond the communication control unit according to a current interactive process.

Step 614: When the communication control unit answers the phone call, the communication control unit transmit the received at least a signal to the interactive process management service unit.

Step 616: Utilize the interactive process management service unit to convert the at least a signal received by the communication control unit to at least an interactive command, and store the at least an interactive command in a command queue.

Step 618: Utilize the broadcasting host interactive command agent program to obtain the at least an interactive command from the interactive process management service unit.

Step 620: Utilize the interactive prize presenting game program to obtain the at least an interactive command in the command queue via the broadcasting host interactive command agent program.

Step 622: When the interactive prize presenting game is completed, utilize the interactive prize presenting game program to transmit at least a prize presenting information to the broadcasting host interactive command agent program.

Step 624: Utilize the broadcasting host interactive command agent program to transmit the at least a prize presenting information to the interactive process management service unit.

Step 626: Utilize the interactive process management service unit to inform the promotion management unit according to an interactive process setting, so as to generate a short message content according to the at least a prize presenting information, and store the short message content in a database unit.

Step 628: Utilize a message service unit to process the short message content, and transmit the short message content to the mobile electronic device.

Step 630: Utilize the interactive process management service unit to inform the communication control unit to hang up the phone.

Step 632: Utilize the communication control unit to hang up the phone.

In addition, the step of utilizing the message service unit to process the short message content can further comprise: checking whether there is any short message content which is not processed in the database unit; and when the message service unit determines there is a short message content which is not processed in the database unit, utilizing the message service unit to process the short message content which is not processed.

In brief, the mobile electronic device interactive application system 200 and the mobile electronic device interactive application method in the third embodiment of the present invention can be utilized to combine with product promotion projects provided by various venders. For example, a vender can put a product premium content (such as a coupon or a prize, etc.) in an interactive electronic game, to let a consumer use a cell phone to play the interactive electronic game by using an outdoor large electronic commercial billboard or an outdoor large display device as a displayer, and obtain the product premium content provided by the vender in the interactive electronic game in the meantime. When the consumer watches an advertisement film of the product provided by the vender displaying on the outdoor large electronic commercial billboard or the outdoor large display device, the consumer can use the cell phone to dial a phone number provided by the advertisement film, so as to enter the mobile electronic device interactive application system 200 of the present invention to perform an interactive electronic game operation. During the interactive electronic game operation, the consumer can use the cell phone as a gaming joystick, and use the outdoor large electronic commercial billboard or the outdoor large display device as a displayer to play the interactive electronic game. Next, after the consumer successfully complete missions in the interactive electronic game, the mobile electronic device interactive application system 200 of the present invention will send a message comprising the product premium content information (such as a product discount price, a coupon, and a prize, etc.) to the consumer, and the consumer can use a following cash flow mechanism via the mobile electronic device interactive application system 200 of the present invention according to the message, so as to obtain the product premium content, or the consumer also can obtain the product premium content in an assigned real shop according to the message. In addition, please note that the above embodiment is only for an illustrative purpose and is not meant to be a limitation of the present invention. For example, the outdoor large electronic commercial billboard or the outdoor large display device mentioned above can be replaced by an indoor electronic commercial billboard or an indoor display device (for example, the electronic commercial billboard or the display device in a public area such as an elevator and traffic station), or a plasma display device, an LCD display device or various electronic display devices in an ordinary family, a meeting room of a company, and a wedding place. Besides, the consumer also can use other kinds of mobile electronic devices (such as a notebook computer, a tablet computer, and a smart phone) to perform the interactive prize presenting game operation with the mobile electronic device interactive application system 200 in the present invention.

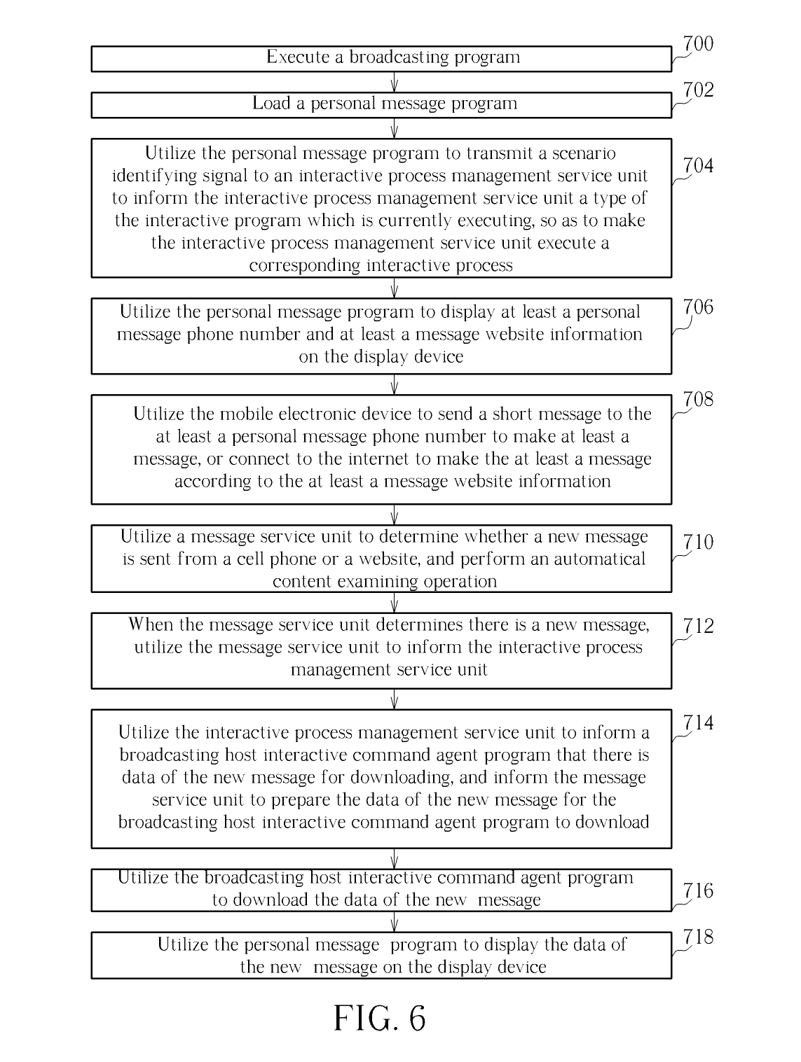

Please refer to FIG. 6. FIG. 6 show a flowchart of a mobile electronic device interactive application method in accordance with a fourth embodiment of the present invention when the interactive operation in FIG. 3 is a personal message operation. Provided that substantially the same result is achieved, the steps of the process flowchart need not be in the exact order shown in FIG. 6 and need not be contiguous, that is, other steps can be intermediate. The mobile electronic device interactive application method in the fourth embodiment of the present invention comprises the following steps:

Step 700: Execute a broadcasting program.

Step 702: Load a personal message program.

Step 704: Utilize the personal message program to transmit a scenario identifying signal to an interactive process management service unit to inform the interactive process management service unit a type of the interactive program which is currently executing, so as to make the interactive process management service unit execute a corresponding interactive process.

Step 706: Utilize the personal message program to display at least a personal message phone number and at least a message website information on the display device.

Step 708: Utilize the mobile electronic device to send a short message to the at least a personal message phone number to make at least a message, or connect to the internet to make the at least a message according to the at least a message website information.

Step 710: Utilize a message service unit to determine whether a new message is sent from a cell phone or a website, and perform an automatically content examining operation.

Step 712: When the message service unit determines there is a new message, utilize the message service unit to inform the interactive process management service unit.

Step 714: Utilize the interactive process management service unit to inform a broadcasting host interactive command agent program that there is data of the new message for downloading, and inform the message service unit to prepare the data of the new message for the broadcasting host interactive command agent program to download.

Step 716: Utilize the broadcasting host interactive command agent program to download the data of the new message.

Step 718: Utilize the personal message program to display the data of the new message on the display device.

In addition, the step of utilizing the message service unit to process the short message content can further comprise: checking whether there is any short message content which is not processed in the database unit; and when the message service unit determines there is a short message content which is not processed in the database unit, utilizing the message service unit to process the short message content which is not processed.

In brief, the mobile electronic device interactive application system 200 and the mobile electronic device interactive application method in the fourth embodiment of the present invention can be utilized for a personal message operation. For example, when a consumer wants to broadcast his/her own personal message content on an outdoor large electronic commercial billboard or an outdoor large display device, the consumer can use a cell phone to dial a personal message phone number displayed on the outdoor large electronic commercial billboard or the outdoor large display device, or use the cell phone to enter a personal message website displayed on the outdoor large electronic commercial billboard or the outdoor large display device via the internet. During the personal message operation, the consumer can edit a personal message content. Next, after the consumer successfully completes editing the personal message content, the mobile electronic device interactive application system 200 of the present invention will send a message comprising the personal message content information (such as a broadcasting date, a broadcasting time, a price, and a message code, etc.) to the consumer, and the consumer can use a following cash flow mechanism via the mobile electronic device interactive application system 200 of the present invention according to the message, so as to pay the money, or the consumer also can pay the money in an assigned real shop according to the message. Next, after the mobile electronic device interactive application system 200 of the present invention confirms that the consumer has paid the money, the mobile electronic device interactive application system 200 will perform an artificial content examining operation or a system automatically content examining operation for the personal message content, so as to determine whether the personal message content is illegal or violates the Public Order and Good. If the mobile electronic device interactive application system 200 of the present invention confirms that the personal message content is not illegal and does not violates the Public Order and Good, then the mobile electronic device interactive application system 200 of the present invention will broadcast the personal message content on the outdoor large electronic commercial billboard or the outdoor large display device. On the contrary, if the mobile electronic device interactive application system 200 of the present invention confirms that the personal message content is illegal or violates the Public Order and Good, then the mobile electronic device interactive application system 200 of the present invention will return the money paid by the consumer back to the consumer. In addition, please note that the above embodiment is only for an illustrative purpose and is not meant to be a limitation of the present invention. For example, after the consumer successfully completes editing the personal message content, if there is no fee for certain practical applications, the steps about paying the money mentioned above can be omitted, and the mobile electronic device interactive application system 200 can directly perform an artificial content examining operation or a system automatically content examining operation for the personal message content, and broadcast the personal message content on the display device after the personal message content passes the artificial content examining operation or the system automatically content examining operation. In addition, the outdoor large electronic commercial billboard or the outdoor large display device mentioned above can be replaced by an indoor electronic commercial billboard or an indoor display device (for example, the electronic commercial billboard or the display device in a public area such as an elevator and traffic station), or a plasma display device, an LCD display device or various electronic display devices in an ordinary family, a meeting room of a company, and a wedding place. Besides, the consumer also can use other kinds of mobile electronic devices (such as a notebook computer, a tablet computer, and a smart phone) to perform the personal message operation with the mobile electronic device interactive application system 200 in the present invention.

Briefly summarized, the mobile electronic device interactive application method and the mobile electronic device interactive application system disclosed by the present invention can let media owners increase the competitive strength of their media, and fascinate consumers to watch and use the media, and precisely quantify the dissemination effects of the media by enriching interactive programs, so as to solve the problems of conventional display device broadcasting system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile electronic device interactive application method, comprising:
broadcasting at least an information on a display device;
utilizing a mobile electronic device to generate at least a signal according to the at least an information, wherein the mobile electronic device at least has a telecommunication function or a wireless network function; and
utilizing an interactive device to receive the at least a signal via a network and to perform an interactive operation according to the at least a signal.

2. The mobile electronic device interactive application method of claim 1, wherein the interactive operation is a ticket booking operation, and the step of broadcasting the at least an information on the display device comprises:
generating a program information according to a type of an interactive program which is currently executing;
generating a data according to the program information, wherein the data comprises at least an interactive ticket booking phone number; and
displaying the program information and the at least an interactive ticket booking phone number on the display device.

3. The mobile electronic device interactive application method of claim 2, wherein the step of broadcasting the at least an information on the display device further comprises:
loading an interactive ticket booking program; and
utilizing the interactive ticket booking program to transmit a scenario identifying signal, so as to inform a type of the interactive program which is currently executing.

4. The mobile electronic device interactive application method of claim 2, wherein the step of utilizing the mobile electronic device to generate the at least a signal according to the at least an information comprises:
utilizing the mobile electronic device to dial the at least an interactive ticket booking phone number according to the program information, so as to generate the at least a signal.

5. The mobile electronic device interactive application method of claim 4, wherein the step of utilizing the interactive device to receive the at least a signal and to perform the interactive operation according to the at least a signal via the network comprises:
converting the received at least a signal to at least an interactive command;
performing a ticket booking operation according to the at least an interactive command to generate a ticket booking information;
generating a short message content according to the ticket booking information; and
transmitting the short message content to the mobile electronic device via the network.

6. The mobile electronic device interactive application method of claim 5, wherein the step of utilizing the interactive device to receive the at least a signal and to perform the interactive operation according to the at least a signal via the network further comprises:
determining whether to answer the phone call when receiving the at least a signal; and
executing the step of converting the received at least a signal to the at least an interactive command when determining to answer the phone call.

7. The mobile electronic device interactive application method of claim 5, wherein the step of transmitting the short message content to the mobile electronic device via the network comprises:
storing the short message content in a database unit;
checking whether there is any short message content which is not processed in the database unit; and
when there is a short message content which is not processed in the database unit, transmitting the short message content which is not processed to the mobile electronic device.

8. The mobile electronic device interactive application method of claim 1, wherein the interactive operation is an interactive prize presenting operation, and the step of broadcasting the at least an information on the display device comprises:
displaying at least an interactive prize presenting game and at least an interactive prize presenting game phone number on the display device according to a type of an interactive program which is currently executing.

9. The mobile electronic device interactive application method of claim 8, wherein the step of broadcasting the at least an information on the display device further comprises:
loading an interactive prize presenting game program; and
utilizing the interactive prize presenting game program to transmit a scenario identifying signal, so as to inform a type of the interactive program which is currently executing.

10. The mobile electronic device interactive application method of claim 8, wherein the step of utilizing the mobile electronic device to generate the at least a signal according to the at least an information comprises:
utilizing the mobile electronic device to dial the at least an interactive prize presenting game phone number, so as to generate the at least a signal.

11. The mobile electronic device interactive application method of claim 10, wherein the step of utilizing the interactive device to receive the at least a signal and to perform the interactive operation according to the at least a signal via the network comprises:
converting the received at least a signal to at least an interactive command;
performing the interactive prize presenting game according to the at least an interactive command.

12. The mobile electronic device interactive application method of claim 11, wherein the step of utilizing the interactive device to receive the at least a signal and to perform the interactive operation according to the at least a signal via the network further comprises:
determining whether to answer the phone call when receiving the at least a signal; and
executing the step of converting the received at least a signal to the at least an interactive command when determining to answer the phone call.

13. The mobile electronic device interactive application method of claim 11, wherein the step of utilizing the interactive device to receive the at least a signal and to perform the interactive operation according to the at least a signal via the network further comprises:
generating at least a prize presenting information when the interactive prize presenting game is completed;
generating a short message content according to the at least a prize presenting information; and
transmitting the short message content to the mobile electronic device via the network.

14. The mobile electronic device interactive application method of claim 13, wherein the step of transmitting the short message content to the mobile electronic device via the network comprises:
storing the short message content in a database unit;
checking whether there is any short message content which is not processed in the database unit; and
when there is a short message content which is not processed in the database unit, transmitting the short message content which is not processed to the mobile electronic device.

15. The mobile electronic device interactive application method of claim 1, wherein the interactive operation is a personal message operation, and the step of broadcasting the at least an information on the display device comprises:
displaying at least a personal message phone number or at least a message website information on the display device according to a type of an interactive program which is currently executing.

16. The mobile electronic device interactive application method of claim 15, wherein the step of broadcasting the at least an information on the display device further comprises:
loading a personal message program; and
utilizing the personal message program to transmit a scenario identifying signal, so as to inform a type of the interactive program which is currently executing.

17. The mobile electronic device interactive application method of claim 15, wherein the step of utilizing the mobile electronic device to generate the at least a signal according to the at least an information comprises:
utilizing the mobile electronic device to send a short message to the at least a personal message phone number to make at least a message, or connect to the internet to make the at least a message according to the at least a message website information.

18. The mobile electronic device interactive application method of claim 17, wherein the step of utilizing the interactive device to receive the at least a signal and to perform the interactive operation according to the at least a signal via the network comprises:
displaying the at least a message on the display device.

19. The mobile electronic device interactive application method of claim 11, wherein the step of utilizing the interactive device to receive the at least a signal and to perform the interactive operation according to the at least a signal via the network further comprises:
performing a content examining operation for the at least a message; and
executing the step of displaying the at least a message on the display device when the at least a message passes the content examining operation.

20. A mobile electronic device interactive application system, comprising:
a display device, for broadcasting at least an information;
a mobile electronic device, for generating at least a signal according to the at least an information, wherein the mobile electronic device at least has a telecommunication function or a wireless network function; and
an interactive device, coupled to the display device, for receiving the at least a signal via a network and performing an interactive operation with the mobile electronic device according to the at least a signal, wherein the interactive device comprises:
a broadcasting module, coupled to the display device, for controlling the display device; and
an interactive module, coupled to the broadcasting module, for receiving the at least a signal via the network and performing the interactive operation with the mobile electronic device according to the at least a signal, and controlling the broadcasting module.

21. The mobile electronic device interactive application system of claim 20, wherein the interactive operation is a ticket booking operation, and the function of the broadcasting module controlling the display device to broadcast the at least an information comprises:
generating a program information according to a type of an interactive program which is currently executing;
generating a data according to the program information, wherein the data comprises at least an interactive ticket booking phone number; and
displaying the program information and the at least an interactive ticket booking phone number on the display device.

22. The mobile electronic device interactive application system of claim 21, wherein the function of the broadcasting module controlling the display device to broadcast the at least an information further comprises:
loading an interactive ticket booking program; and
utilizing the interactive ticket booking program to transmit a scenario identifying signal, so as to inform a type of the interactive program which is currently executing.

23. The mobile electronic device interactive application system of claim 21, wherein the function of the mobile electronic device generating the at least a signal according to the at least an information comprises:
utilizing the mobile electronic device to dial the at least an interactive ticket booking phone number according to the program information, so as to generate the at least a signal.

24. The mobile electronic device interactive application system of claim 23, wherein the function of the interactive device receiving the at least a signal and to perform the interactive operation according to the at least a signal via the network comprises:
converting the received at least a signal to at least an interactive command;
performing a ticket booking operation according to the at least an interactive command to generate a ticket booking information;
generating a short message content according to the ticket booking information; and
transmitting the short message content to the mobile electronic device via the network.

25. The mobile electronic device interactive application system of claim 24, wherein the function of the interactive device receiving the at least a signal and to perform the interactive operation according to the at least a signal via the network further comprises:
determining whether to answer the phone call when receiving the at least a signal; and
executing the step of converting the received at least a signal to the at least an interactive command when determining to answer the phone call.

26. The mobile electronic device interactive application system of claim 24, wherein the function of transmitting the short message content to the mobile electronic device via the network comprises:
storing the short message content in a database unit;
checking whether there is any short message content which is not processed in the database unit; and
when there is a short message content which is not processed in the database unit, transmitting the short message content which is not processed to the mobile electronic device.

27. The mobile electronic device interactive application system of claim 20, wherein the interactive operation is an interactive prize presenting operation, and the function of the broadcasting module controlling the display device to broadcast the at least an information comprises:
displaying at least an interactive prize presenting game and at least an interactive prize presenting game phone number on the display device according to a type of an interactive program which is currently executing.

28. The mobile electronic device interactive application system of claim 27, wherein the function of the broadcasting module controlling the display device to broadcast the at least an information further comprises:
loading an interactive prize presenting game program; and
utilizing the interactive prize presenting game program to transmit a scenario identifying signal, so as to inform a type of the interactive program which is currently executing.

29. The mobile electronic device interactive application system of claim 27, wherein the function of the mobile electronic device generating the at least a signal according to the at least an information comprises:
utilizing the mobile electronic device to dial the at least an interactive prize presenting game phone number, so as to generate the at least a signal.

30. The mobile electronic device interactive application system of claim 29, wherein the function of the interactive device receiving the at least a signal and to perform the interactive operation according to the at least a signal via the network comprises:
converting the received at least a signal to at least an interactive command;
performing the interactive prize presenting game according to the at least an interactive command.

31. The mobile electronic device interactive application system of claim 30, wherein the function of the interactive device receiving the at least a signal and to perform the interactive operation according to the at least a signal via the network further comprises:
determining whether to answer the phone call when receiving the at least a signal; and
executing the step of converting the received at least a signal to the at least an interactive command when determining to answer the phone call.

32. The mobile electronic device interactive application system of claim 30, wherein the function of the interactive device receiving the at least a signal and to perform the interactive operation according to the at least a signal via the network further comprises:
generating at least a prize presenting information when the interactive prize presenting game is completed;
generating a short message content according to the at least a prize presenting information; and
transmitting the short message content to the mobile electronic device via the network.

33. The mobile electronic device interactive application system of claim 32, wherein the function of transmitting the short message content to the mobile electronic device via the network comprises:
storing the short message content in a database unit;
checking whether there is any short message content which is not processed in the database unit; and
when there is a short message content which is not processed in the database unit, transmitting the short message content which is not processed to the mobile electronic device.

34. The mobile electronic device interactive application system of claim 20, wherein the interactive operation is a personal message operation, and the function of the broadcasting module controlling the display device to broadcast the at least an information comprises:
displaying at least a personal message phone number or at least a message website information on the display device according to a type of an interactive program which is currently executing.

35. The mobile electronic device interactive application system of claim 34, wherein the function of the broadcasting module controlling the display device to broadcast the at least an information further comprises:
loading a personal message program; and
utilizing the personal message program to transmit a scenario identifying signal, so as to inform a type of the interactive program which is currently executing.

36. The mobile electronic device interactive application system of claim 34, wherein the function of the mobile electronic device generating the at least a signal according to the at least an information comprises:
utilizing the mobile electronic device to send a short message to the at least a personal message phone number to make at least a message, or connect to the internet to make the at least a message according to the at least a message website information.

37. The mobile electronic device interactive application system of claim 36, wherein the function of the interactive device receiving the at least a signal and to perform the interactive operation according to the at least a signal via the network comprises:
displaying the at least a message on the display device.

38. The mobile electronic device interactive application system of claim 37, wherein the function of the interactive device receiving the at least a signal and to perform the interactive operation according to the at least a signal via the network further comprises:
performing a content examining operation for the at least a message; and
executing the step of displaying the at least a message on the display device when the at least a message passes the content examining operation.
